(19) United States
(12) Patent Application Publication
(10) Pub. No.: US 2023/0219066 A1
(43) Pub. Date: Jul. 13, 2023

(54) COPPER (CU)-DOPED TITANIA COATING LAYER

(71) Applicant: ELO TOUCH SOLUTIONS, INC., Knoxville, TN (US)

(72) Inventors: Song BAI, Suzhou (CN); Tiancun CHEN, Suzhou, TN (US); Na HAN, Suzhou, TN (US)

(21) Appl. No.: 18/069,871

(22) Filed: Dec. 21, 2022

(30) Foreign Application Priority Data
Jan. 7, 2022 (CN) 202210012586.8

(51) Int. Cl. B01J 21/06; B01J 23/72; B01J 35/00; B01J 37/02; B01J 37/04

(52) U.S. Cl. CPC B01J 21/063; B01J 23/72; B01J 35/004; B01J 37/0219; B01J 37/04

(57) ABSTRACT

Some embodiments include a copper (Cu)-doped titania coating layer, including a titania matrix and Cu element doped therein, characterized in that a doping amount of the Cu element is 4-25 mol % of the entire cured coating layer. Some embodiments include a coating composition of the coating layer, and a process for preparing the coating composition, including: (1) preparing a solution comprising a titanium alkoxide and a diluent; (2) preparing a solution comprising a copper precursor compound and a diluent, (3) mixing the above two solutions to obtain a precursor mixture of the composition, wherein in the above steps (1) and (2), the pH value of the solutions is controlled to in the range of 0.1 to 6, and the solutions of steps (1) and (2) are substantially free of water.

### CROSS-REFERENCE TO RELATED APPLICATION

This application claims priority to Chinese Application No. 202210012586.8 filed Jan. 7, 2022, entitled “Abrasion-Resistant Anti-Microbial Coating on Chemically Strengthened Touchscreen Glass,” which is incorporated herein by reference in its entirety.

### BACKGROUND

### Field

The present disclosure relates to a copper (Cu)-doped titania coating layer, a coating composition for preparing the coating layer, a process for preparing the coating composition and an article coated with the coating layer.

### Background Art

In many environmental spaces, such as domestic, community, transportation, office, and medical private or public areas, it is necessary to subject surfaces of various items and devices to antimicrobial treatments, for example, for a number of commonly used items having substrate surfaces of glass, ceramic and steel, such as electronic and electrical devices.

### SUMMARY

Some embodiments include a system, method, and/or combination(s) or sub-combination(s) thereof, for copper (Cu)-doped titania coating layer, a coating composition for preparing the coating layer, a process for preparing the coating composition and an article coated with the coating layer. The Cu-doped titania coating layer according to the invention is suitable for spraying and it has excellent antimicrobial properties as well as maintained or improved mechanical properties and adhesions.

Further embodiments, features, and advantages of the present disclosure, as well as the structure and operation of the various embodiments of the present disclosure, are described in detail below with reference to the accompanying drawings.

### BRIEF DESCRIPTION OF THE DRAWINGS/FIGURES

The application file contains at least one drawing executed in color. Copies of this patent or patent application publication with color drawing(s) will be provided by the Office upon request and payment of the necessary fee. The accompanying drawings, which are incorporated herein and form part of the specification, illustrate the present disclosure and, together with the description, further serve to explain the principles of the disclosure and to enable a person skilled in the relevant art(s) to make and use the disclosure.

FIG. 1a illustrates an example of a substrate surface and the coating layer of Example 1 before and after sintering, according to an exemplary embodiment of the disclosure;

FIG. 1B illustrates an example of a substrate surface and the coating layer of Example 1 before and after abrasion, according to an exemplary embodiment of the disclosure;

FIG. 2 illustrates examples of XPS results of copper (Cu)-amount in the coating layers of Examples 1 to 4, in which index A corresponds to Example 4, index B corresponds to Example 2, index C corresponds to Example 3 and index D corresponds to Example 1, according to an exemplary embodiment of the disclosure;

FIG. 3 illustrates an example of a substrate surface and coating layer of Example 4 after sintering, according to an exemplary embodiment of the disclosure;

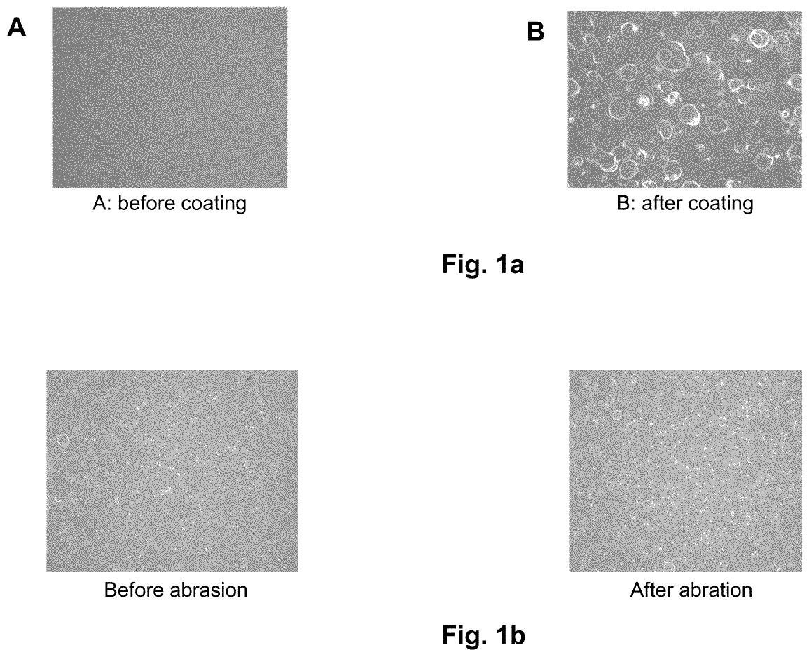

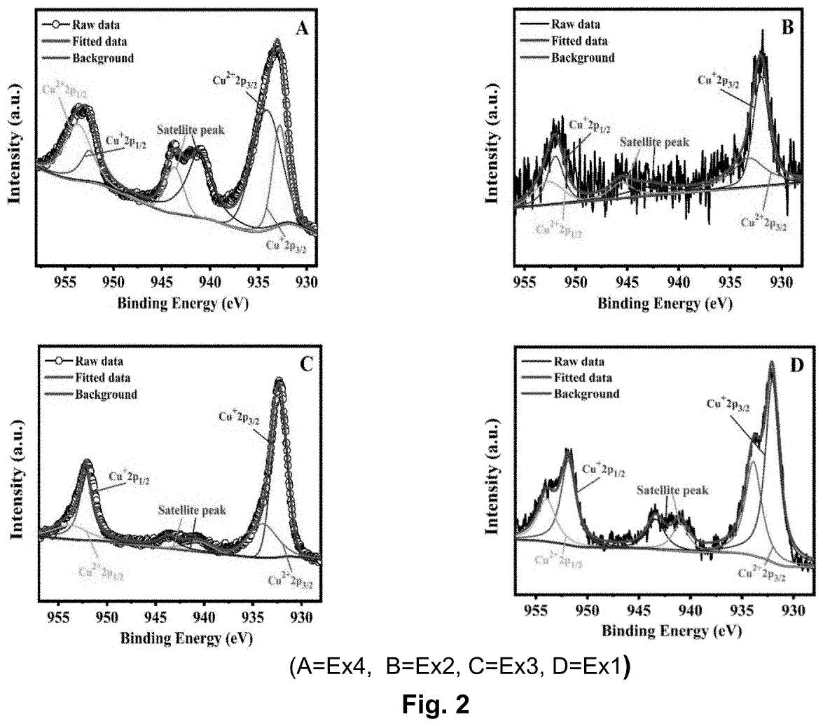

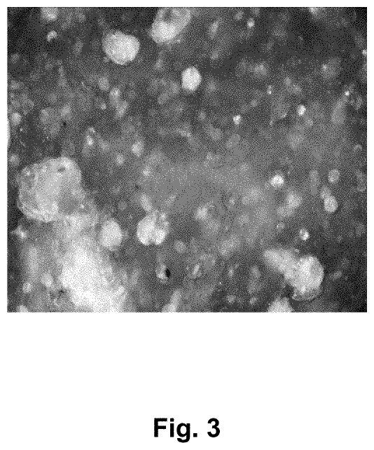

The present disclosure will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

The following Detailed Description of the present disclosure refers to the accompanying drawings that illustrate exemplary embodiments consistent with this disclosure. The exemplary embodiments will fully reveal the general nature of the disclosure that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein. Therefore, the detailed description is not meant to limit the present disclosure.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Titania, especially anatase-type titania, attracts a large number of experts at home and abroad to study it due to its special photosensitive characteristics. For example, it has been found that titania powder will be activated by the photo catalytical reaction with the light having appropriate wavelengths, and after reacting atmospheric oxygen and water, it can produce a large quantity of reactive oxygen species which can have antimicrobial functions. Therefore, the titania may be widely used in applications of sewage purifications and environmental protections.

The titania is typically used in a powder form. These powders are often used as white pigments in applications of coating layers. If they are directly spray coated, problems such as bad adhesion, bad homogeneity and insignificant antimicrobial properties, will occur, limiting their applications in the field of electronic materials.

Recently, people try to modify the titania by the means of copper (Cu)-doping. For example, the document “Preparation and photocatalytic performance of Cu-doped TiO₂ nanoparticles”, Xi-jia YANG et al., Science Direct 25(2015) 504-509 studies a method for modifying titania nanoparticles by doping with Cu element so that the antibacterial properties of the particles are improved to an extent. The method investigates the nano-powder materials with a Cu doping amount of 0% to 2%, and the powder materials are synthesized by a sol-gel method.

The authors of this document consider that the doping amount of Cu reaching or exceeding 2.0%, would decrease the photocatalytic performance of the titania to a level similar to that of undoped titania, thereby compromising its antimicrobial properties. However, the lower Cu doping amount in this document possibly enables Cu ions not to sufficiently exert the antimicrobial performances thereof. Additionally, what is prepared in the sol-gel synthesis method employed in this document is still a powder product which is not favorable for coating applications of the titania on substrates such as glass, particularly, e.g., by spraying. Moreover, the powders in the document have to be sintered at a very high temperature at 450° C. In this case, although the adhesion may be improved, the mechanical strength of a substrate such as glass, may be compromised and meanwhile the antimicrobial properties are also impaired.

Additionally, there are attempts in the prior art to dope a titania matrix with halogens, such as F, to improve the photocatalytic activity of the titania so that the activity can be induced with visible light, and thus relatively high antibacterial activities are exhibited. However, the introduction of a fluorine dopant complicates the formulation and preparation of the titania coating layer and cannot make any contributions to the improvement of the bactericidal effects of Cu ions. Besides, the introduction of F ions may weaken the covalent bonding between the substrate surface and the coating layer, thereby impairing the bonding strength there between and thus affecting negatively the adhesion of the coating layer on the substrate surface and the durability of the antibacterial surface.

Accordingly, at present, there is still a need to further improve the antimicrobial properties of titania coatings, in particular Cu-doped titania coatings, and meanwhile maintaining or improving the mechanical properties and the adhesion of the titania coating layer. In particular, it would also be desirable to prepare a titania coating composition suitable for spray application rather than powder coating.

Accordingly, a first aspect of the present application relates to a Cu-doped titania coating layer, comprising a titania binder and Cu element doped therein, characterized in that a doping amount of the Cu element is in the range of 4 to 25 mol % based on the entire cured coating layer and calculated as Cu.

A second aspect of the present application relates to a coating composition for application on a substrate, comprising 5.5 to 25.0 wt %, preferably 6.5 to 22.0 wt %, such as 8.0 to 15.0 wt % of a titanium alkoxide, 0.15 to 4.5 wt %, such as 0.20 to 4.0 wt % or 0.30 to 3.5 wt % of a copper ion precursor, an acid containing stabilizer and an alcohol containing diluent, based on the total weight of the coating composition not counting water.

A third aspect of the present application relates to a process of preparing a coating composition, especially the one as stated above, comprising: (1) preparing a solution comprising a titanium alkoxide and a diluent; (2) preparing a solution comprising a copper precursor compound and a diluent, (3) mixing the above two solutions to obtain a precursor mixture of the composition, wherein in the above steps (1) and (2), the pH of the solutions is controlled in the range of 0.1 to 6, and the solutions of steps (1) and (2) are substantially free of water.

A fourth aspect of the present application relates to a method of preparing a titania coating layer on a substrate, comprising: (1) applying the coating composition according to the second aspect or the coating composition prepared by the method according to the third aspect on a substrate, and (2) curing the applied coating composition by elevating temperatures.

A fifth aspect of the present application relates to an article coated with a Cu-doped titania coating layer according to the invention.

The inventors have found that the coating composition according to the invention may be favorably applied in the form of a solution for direct application rather than a powder suspension (for example, powders are prepared by a sol-gel method and then they are formulated into a coatable powder suspension), and thus it is applicable for a spraying coating on a substrate. In addition, after the coating composition is applied, it can be baked at a relatively low temperature, such as lower than 420° C., and thus the cured titania coating layer can keep excellent mechanical properties such as wear resistance while still having excellent adhesions. Meanwhile, since the coating layer can obtain a high amount of Cu⁺ ions, its antimicrobial performances can be significantly improved.

The Cu-doped titania coating layer according to the invention uses titania as the binder. As understood for a skilled person, the “binder” refers to a non-volatile film-forming component in the coating layer, which constitutes the matrix phase of the coating layer. Films composed of titania are particularly suitable to be adhered to substrates such as glass, ceramic and steels.

In the context of the present application, the “Cu-doped titania coating layer” or the “titania coating layer” refers to a layer formed by curing a liquid coating composition after it is coated on a substrate. In this process, the titanium alkoxide in the coating composition will hydrolyze at elevated temperatures to form the titania binder. In particular, on the substrate, the titania coating layer of the invention is in the form of a continuous coating layer constituted by an O—Ti—O network but not in the form of a powder coating layer constituted by discrete TiO₂ particles or powders.

In one preferred embodiment of the invention, the titania coating layer consists of a matrix phase constituted by an O—Ti—O network and a doping ion which is a Cu ion, the doping amount of the Cu element being 4 to 25 mol %, for example 6 to 20 mol % or 8 to 16 mol %, based on the entire coating layer. The “Cu ion” includes monovalent ion (Cu^{t}) and divalent ion (Cu′) of Cu.

Titanium alkoxides (also known as titanates) refer to compounds having the general formula Ti(—O—R)₄, wherein R denotes a linear or branched C₁-C₈, preferably C₁-C₄, alkyl group. Examples of titanium alkoxides suitable for the invention include titanium methoxide, titanium ethoxide, titanium propoxide, titanium isopropoxide, titanium butoxide, titanium isobutoxide, and the like, preferably titanium isopropoxide, titanium butoxide, and titanium isobutoxide, especially titanium tetrabutoxide also referred as tetrabutyl titanate.

The copper ion, particularly Cu⁺, is known to have good antimicrobial effects and thus it is beneficial to incorporate it into a titania coating layer. The copper ion may be added to a solution of titanium alkoxides in its precursor form, thereby being doped into the titania structure upon curing at high temperatures.

The copper ion precursor itself is not particularly limited. According to one preferred embodiment of the present invention, the copper ion precursor compound includes nitrates, carboxylates such as acetates, formates and the like, sulfates of copper and various hydrates thereof. Preferably, copper nitrate and its hydrates can be used as the copper ion precursor compound. In the present invention, halides, such as fluorides or chlorides, of copper are not suitable as the copper ion precursor compound, because it has been found that the presence of a halogen element may inhibit the formation of covalent crosslinks between a coating layer and a substrate surface, thereby affecting negatively the adhesion and antibacterial effects of the coating layer.

In the titania coating layer of the invention, copper ions should be doped into the finally cured titania coating layer in a proportion of 4 to 25 mol %. If the Cu ion is doped in an amount of less than 4 mol %, it possibly cannot sufficiently exert its antimicrobial effects. If the Cu ion is doped in an amount of higher than 25 mol %, the doping of the copper ion into the titania matrix will be influenced, so as to partially precipitate CuO crystals, thereby negatively affect the surface activities of the titania coating layer and the overall performances of the material, but also the appearance and coating effects of the coating layer.

It has been furthermore found that the ratio of Cu⁺/Cu²⁺ in the titania coating layer of the invention may be more than 1:1, preferably more than 1:3, which is advantageous to further improve antimicrobial performances. In the prior art (e.g. a sol-gel process), the sintering temperature of coating layers is typically very high, e.g. up to 450° C. or higher, which causes the proportion of Cu²⁺ ions to be significantly increased. Additionally, the doping amount of Cu⁺ in titania coating layers produced by the prior art methods is typically low. With the desire of increasing the Cu⁺ doping amount (for example, exceeding 3 mol %), it would also cause the proportion of Cu²⁺ ions to be significantly increased.

Preferably, the titania coating layer of the invention does not contain halogens, particularly F, as a doping ion, and thus the adverse effects brought by F-doping can be avoided. It is also preferable that the titania coating layer of the invention contains substantially only the Cu element as the doping ion in view of coloring, anti-oxidation, toxicity, and easy availability. This means that the Cu element may comprise more than 99%, such as 99.5% or 99.8% or 99.9% or 100% of doped metal ions, and no other heavy metal ions such as iron, manganese, zinc, lead, tin, mercury, cadmium, silver, and the like, are intentionally doped. If present, it is preferred that these other heavy metal ions are present in an amount of less than 0.5 mol %, more preferably less than 0.1 mol %, or absent.

The titania coating layer according to the invention may be produced from a coating composition as its precursor material. Those skilled in the art, based on their own chemical knowledge and common knowledge of production practice, may select suitable titanium alkoxides and copper precursor compounds in the coating composition and amounts thereof, to obtain a titania coating layer having a desired Cu-doping amount.

Hence, as described above, the invention also relates to a coating composition for application to a substrate, comprising 8.5 to 20 wt % of a titanium alkoxide, 0.15 to 4.5 wt % of a copper ion precursor, an acid containing stabilizer and an alcohol containing diluent, based on the total weight of the coating composition not counting water.

In order to prepare the coating composition, the following method is required, which comprises: (1) preparing a solution comprising a titanium alkoxide and a diluent; (2) preparing a solution comprising a copper precursor compound and a diluent, (3) mixing the above two solutions to obtain a precursor mixture of the composition, wherein in the above steps (1) and (2), the pH of solutions is controlled in the range of 0.1 to 6, and the solutions of steps (1) and (2) are substantially free of water.

The inventors of the application have found that it is critical to control the pH in the range of 0.1-6, preferably 0.3-5.4, e.g. about 0.5-4.5 or 0.9-4.1, during the preparation of the solution comprising the titanium alkoxide and the copper precursor compound, because this can leads to the formation of a very stable final mixed solution but not the formation of a sol. Thus, the preparation of a coating composition, particularly concentrated form or aqueous solutions thereof, suitable for spray applications becomes possible. Hence, because a solution rather than a sol is formed, the invention does not require a step of a drying treatment at elevated temperatures to form the solution into a gel and/or further sinter (e.g., at temperatures above 425° C., such as 450° C.) it into powders, as required by a common sol-gel process.

Additionally, controlling the pH of the solutions of a titanium alkoxide and a copper precursor compound as described above can lead to the following advantages:

(1) The copper precursor compound of the prepared coating composition can be stably present in the solution at a higher concentration, and doping a higher concentration of Cu ions, particularly Cu⁺ ions, into the final titania coating layer can be accomplished.

(2) The prepared titania coating solution can be stabilized as a whole, to avoid settling and deposition, so that it is especially suitable for spray application onto substrates such as glass, ceramic and steel.

(3) Spraying devices may be effectively protected, so as to assure operation feasibility and stability.

Steps (1) and (2) may be carried out in any order, but in both steps the pH of the solutions has to be controlled within the range of 0.1 to 6. Advantageously, in the mixing step (3), the pH value is still maintained in the required range, preferably until prior to applications. The control of the pH values may be accomplished by those pH adjusting methods known to those skilled in the art, for example by selecting a solvent or diluent having a suitable pH value to dissolve the titanate and the Cu precursor compound, or by adding a suitable pH adjuster.

Additionally, in the dissolving processes of steps (1) and (2), water or materials containing water (rather than crystal water) should not be added or used as far as possible, to enable the solutions obtained in the steps (1) and (2) to be substantially free of water. Preferably, in the step (3) of mixing the solutions prepared in the steps (1) and (2) and before the dilution by adding water for final applications, e.g. spraying, the prepared mixed solution or concentrated solution is also rendered to be substantially free of water. In the dissolving process, the addition of water is unfavorable for the long term storage of the mixed solution, and ready to cause precipitations, particularly titanium precipitations. In the present application, the term “substantially free of water” refers to containing less than 0.1 wt %, preferably less than 0.05 wt % or less than 0.01 wt % of water, based on the total weight of a solution, or being completely free of water.

The mixing operation of the step (3), being not particularly limited, comprises adding a titanium alkoxide solution to a prepared solution of the copper precursor compound, or vice versa. After the two solutions were contacted, under sufficiently stirring, a uniform mixed solution may be obtained.

The steps (1) to (3) or the process for preparing the coating composition that comprises these steps may be performed at an ambient temperature, e.g., room temperature, or such as 10-30° C. or 15-25° C. Preferably, the dissolving and the mixing may be performed under stirring.

The diluents used in the steps (1) to (3) should be able to help the titanium alkoxide and the copper precursor compound to form a stable solution, preferably alcohol containing diluents.

Suitable alcohols include aliphatic alcohols, preferably C₁-C₈, more preferably C₂-C₆ alcohols, such as ethanol. Advantageously, alcohols with a purity higher than 99% or 99.5% or alcohols in an anhydrous form may be used to dissolve the titanium alkoxide and the copper precursor, because the presence of water can causes the hydrolysis of the titanium alkoxide, which is detrimental to the stable progress of the subsequent spraying step.

The alcohols are advantageously used in an amount of 20.0 to 90.0 wt. %, preferably 24.0 to 86.0 wt. %, such as 33.0 to 65.0 wt %, based on the total weight of the coating composition not counting water.

Typically, besides better controlling the pH value in the required range, it is also preferred to add a stabilizer, in particular an acid containing stabilizer, in at least one of the steps (1) to (3) in order to stabilize the solutions to facilitate storage and transportation. Suitable stabilizers include acids selected from, for example, organic acids or non-oxidative inorganic acids, in particular mono- or dicarboxylic acids, such as C₁-C₈ or C₁-C₆ aliphatic acids or C₆-C₁₂ aromatic carboxylic acids, such as acetic acid, propionic acid, butyric acid, oxalic acid, citric acid, benzoic acid, and the like, preferably acetic acid such as glacial acetic acid, or hydrochloric acid, sulfuric acid or nitric acid. It is preferred to add an acid containing stabilizer in the steps (1) and (2) as described above.

The acids are advantageously used in an amount of 1.0 to 70.0 wt %, preferably 1.3 to 67.0 wt %, such as 9.0 to 55.0 wt %, based on the total weight of the coating composition not counting water.

Furthermore, acetylacetone may be advantageously added in at least one of the steps (1) to (3), which is favorable for the dissolution of possible precipitates, thereby exerting the function of stabilizing the solutions. If used, the acetylacetone may be advantageously used in an amount of 0.5 to 2.3 wt %, preferably 0.7 to 2.1 wt % or 1.5 wt %, based on the total weight of the coating composition not counting water. If desired, the acetylacetone may be preferably added in the step (3).

In one exemplary embodiment, when preparing the precursor of a titania coating layer, i.e., the coating composition to be applied onto a substrate, both an alcohol (particularly ethanol) as the solvent and a stabilizer containing acids (particularly glacial acetic acid) are used, and in the formulation process, the ratio of all added alcohol to all added acid is in the volume ratio range of 75:1 to 1:2, e.g. 50:1 to 1:1, 30:1 to 1:1, 10:1 to 1:1, 5:1 to 2:1. Such ratios are favorable for dissolving the titanium alkoxide and the copper precursor compound and controlling the pH values within the required range.

It is advantageous if using the acid, alcohol and optional acetyl acetone with the above amounts, because this is very favorable for controlling and maintaining the required pH value, thereby maintaining the stability of the solutions.

It is also preferred that the ratio of total solvents (including stabilizers and diluents) to total solutes (including the titanium alkoxide and the copper ion precursor compounds) is greater than 5:1 by volume based on the total weight of the titania coating mixture not counting water.

The coating composition according to the invention may be formulated into a concentrated form containing no water or only a tiny amount (e.g., less than 1 wt %, 0.5 wt %, 0.1 wt % or 0.02 wt %) of water, or into an aqueous solution form obtained after being diluted by adding water. In one advantageous embodiment, after being diluted by adding water, in particular after being diluted by adding water before applications via such as spraying, the coating composition may be formulated to contain 0.8-1.6 wt %, e.g., 0.9-1.2 wt % of a titanium alkoxide such as Ti(OC₄H₉)₄, 0.02-1.4 wt %, preferably 0.05-1.2 wt % of a copper ion precursor such as Cu(NO₃)₂·3H₂O, an acid containing stabilizer, and an alcohol containing diluent, based on the total weight of the coating composition after the addition of water.

Subsequently, the coating composition may be applied to a substrate (preferably by spraying, dipping, printing and vapor deposition, particularly preferably spraying) and afterwards it is cured at elevated temperatures to produce a titania coating layer doped with a high concentration of Cu. In this process, according to needs, the prepared coating composition may be diluted with water before its application onto the substrate, to facilitate the subsequent applications, e.g., spraying. For example, after a water-free uniform mixture of the titanium alkoxide and the copper precursor solution is prepared through the steps (1) to (3), it is diluted by adding an appropriate amount of water, for example, by adding 60 to 98 wt %, such as 70 to 96 wt % or 85 to 95 wt % of water based on the total weight of the coating composition after being diluted by adding water.

Unlike the sol-gel method in the prior art, the coating compositions according to the invention, after being prepared into substantially water-free solutions comprising the titanium alkoxide and the copper precursor compound, may be not allowed to be converted to gels by drying or digesting them at elevated temperature. They may be stably applied, particularly sprayed onto a substrate after diluting with water in the form of a solution.

Additionally, after it is applied, for example by spraying, onto a substrate in the form of a solution, the coating composition according to the application may be directly cured to crystalize at elevated temperatures without a drying step. Accordingly, the invention also relates to a process for preparing a titania coating layer on a substrate, comprising: (1) applying the coating composition as described above or the coating composition prepared according to the method as described above to a substrate, and (2) curing the applied coating composition by elevating temperatures.

Here, the curing may be performed in an apparatus suitable for baking to form an anatase-type titania coating layer. One advantage of the coating composition of the invention resides in that it may be cured at a relatively low temperature, such as below 450° C., preferably 350 to 420° C. This is very advantageous for keeping the strength of the substrate and the antimicrobial properties of the coating layer.

As described above, it is preferred that the prepared coating composition is applied to a substrate in the form of a solution, preferably by spraying.

Substrates that are suitable to be applied with the titania coating layer of the invention include glass, ceramics, various inorganic composites, and the like.

The titania coating layers according to the invention have excellent antimicrobial properties. It has been found that the titania coating layers according to the invention can achieve antibacterial efficiency against bacteria (e.g., Escherichia coli, Staphylococcus aureus, etc.), and viruses (e.g. human coronavirus, etc.) of 99.9% or above.

In addition, the application further relates to articles comprising the titania coating layers of the invention, and suitable examples of such articles include display screens in public places, computer screens, cell phone screens, touch surfaces of hospital electronic devices, and the like.

### EXAMPLES

The present application is further described below with the reference to examples.

However, the present application is not limited to the following examples. Moreover, the percentage data and the proportions in the description of the present application are based on weight, unless explicitly illustrated otherwise.

Illustrations of Raw Materials

| Name(s) | Description |
|---|---|
| Tetrabutyl | Purity > 98.0%, purchased from Sinopharm |
| titanate | Chemical Reagent Co., Ltd |
| Trihydrated | Purity > 99.0%, analytically pure, purchased from |
| copper nitrate | Sinopharm Chemical Reagent Co., Ltd |
| Anhydrous | Purity > 99.8%, guarantee reagent, purchased from |
| ethanol | Sinopharm Chemical Reagent Co., Ltd |
| Glacial | Purity > 99.5%, analytically pure, purchased from |
| acetic acid | Sinopharm Chemical Reagent Co., Ltd |
| Acetylacetone | Purity > 99.0%, analytically pure, purchased from |
| | Sinopharm Chemical Reagent Co., Ltd |

### Preparation Examples

### Example 1

Firstly, 10 ml of tetrabutyl titanate were dropwise added into 70 ml of a solvent (a mixture of anhydrous ethanol and glacial acetic acid in a ratio of 1:1) according to a volume ratio of 1:7, and uniformly mixed under stirring with a glass rod, to provide a tetrabutyl titanate solution. Subsequently, 0.70 g of trihydrated copper nitrate solids were dissolved in 22 ml of the solvent comprising anhydrous ethanol and glacial acetic acid in a ratio of 1:1, and they were stirred until the solids were fully dissolved, to provide a copper nitrate solution. The copper nitrate solution was dropwise added into the tetrabutyl titanate solution, and after being mixed uniformly by stirring, they were added with 1 ml of acetylacetone. The stirring was continued until the solution was sufficiently mixed to be uniform, and a precursor solution of the titania coating layer was obtained.

Then, the obtained precursor solution of the titania coating layer (the solution of a coating composition) was diluted to 1000 ml by adding water, and the diluted solution was directly applied onto a glass substrate by spraying and baked for 1 h at 400° C., to provide a glass with a Cu-doped TiO₂ coating layer.

The matrix phase of the obtained TiO₂ coating layer was TiO₂, the doping amount of Cu ions was measured to be 8.92 mol %, and the Cu¹⁺:Cu²⁺ ratio in the product was measured to be 1.64.

### Example 2

The operation of Example 1 was repeated except that 0.22 g of trihydrated copper nitrate were used.

The matrix phase of the obtained TiO₂ coating layer was TiO₂, the doping amount of Cu ions was measured to be 3.13 mol %, and the Cu¹⁺:Cu²⁺ ratio in the product was measured to be 1.37.

### Example 3

The operation of Example 1 was repeated except that 1.16 g of trihydrated copper nitrate were used.

The matrix phase of the obtained TiO₂ coating layer was TiO₂, the doping amount of Cu ions was measured to be 14.07 mol %, and the Cu¹⁺:Cu²⁺ ratio in the product was measured to be 1.18.

### Example 4

The operation of Example 1 was repeated except that 5.82 g of trihydrated copper nitrate were used.

The matrix phase of the obtained TiO₂ coating layer was TiO₂, and the doping amount of Cu ions was measured to be 46.04 mol %.

### Example 5

The operation of Example 1 was repeated except that 0.07 g of trihydrated copper nitrate were used.

The matrix phase of the obtained TiO₂ coating layer was TiO₂, and the doping amount of Cu ions was measured to be 1 mol %.

### Example 6

The operation of Example 1 was repeated except that no glacial acetic acid was added in both dissolution processes. The solution was unstable with the occurrence of a small amount of white precipitates. Therefore, the subsequent applying and curing steps were not performed.

### Example 7

The operation of Example 1 was repeated except that the solvent was not added with anhydrous ethanol and the tetrabutyl titanate was directly dissolved in glacial acetic acid. In the first step of dropwise adding the tetrabutyl titanate to the solvent and mixing them by stirring, emulsification emerged in the solution, and after still standing, white precipitates and strong pungent smell were observed. Therefore, the subsequent applying and curing steps were not performed.

### Example 8

The operation of Example 1 was repeated except that the volume ratio of ethanol to glacial acetic acid in the solvent was 70:1; and that in the third step of dropwise adding the copper nitrate solution into the tetrabutyl titanate solution, the amount of Cu in the solution was set to be 10%, after the solution was mixed uniformly, a clear solution was observed with no occurrence of precipitates.

Then, the obtained precursor solution of the titania coating layer (a solution of the coating composition) was diluted to 1000 ml by adding water. The diluted solution was directly sprayed onto a glass substrate, and baked for 1 h at 400° C., to provide a glass with a Cu-doped TiO₂ coating layer.

### Example 9

The operation of Example 1 was repeated except that the ratio of ethanol to glacial acetic acid in the solvent was 1:70. In the first step of dropwise adding the tetrabutyl titanate to the solvent and mixing them by stirring. Emulsification emerged in the solution, and after still standing, white precipitates were observed. Therefore, the subsequent applying and curing steps were not performed.

In the above examples, the controlled pH values in steps (1) and (2) are measured and recorded in the following table.

### Performance Tests

The glass with a Cu-doped TiO₂ coating layer prepared as described above was subjected to performance tests as illustrated below, and the test results were shown in Table 1.

### Amounts of Cu in Coating Layers

The amounts of Cu were determined by an XPS test.

XPS apparatus: Manufacturer: ThermoFisher, Model: thermo Scientific K-Alpha.

Testing conditions: Vacuum degree of the analysis chamber: approximately 5×10⁻⁷ mbar, X-ray source: monochromatized AlKa source (Mono AlKa), energy: 1486.6 eV, voltage: 12 KV, beam current: 6 mA, scanning mode of the analyzer: CAE

Some embodiments include a process of preparing a titania coating layer on a substrate, comprising: (1) applying a coating composition or the coating composition prepared by a process on a substrate, and (2) curing said applied coating composition by elevating temperatures. The curing can be performed at a temperature below 450° C., preferably 350 to 420° C. The coating composition can be applied to the substrate in the form of an aqueous solution by spraying. The substrate can include glass, ceramic, and/or various inorganic composites. In some embodiments, an article including the titania coating layer can include display screens in public places, computer screens, cell phone screens, and touch surfaces of hospital electronic devices.

### Antimicrobial Properties

Entrusting Guangdong Province Microbiological Analysis and Testing Center to conduct anti-microbial performance testing according to the standard of antibacterial tests: ISO 27447: 2009 and standard of Human coronavirus tests: IS018061-2014.

Antiviral test results of the Ex1 (e.g., Example 1) sample against the human coronavirus (HCoV-229E) (ATCC VR-740) may refer to Report No. 2021FM05821R01D, while antibacterial test results against Escherichia coli virus and Staphylococcus aureus may refer to Report No. 2021FM02989R01D.

Antibacterial test results of the Ex5 sample against Escherichia coli virus and Staphylococcus aureus may refer to Report No. 2020FM35046R01D.

The sample of Ex1 according to the invention is superior to the sample of Ex5 in terms of the tested antimicrobial property.

### Abrasion Resistance

Rubbing was performed by referring to enterprise standard ES601150, wherein the test apparatus was a general steel wool rubbing machine, with the rubbing time of 3000 cycles under the load of 1 kg, using the rubbing medium EF74 rubber, the rubbing stroke of 5 cm and the speed of 60 cycles/min. Subsequently, a microscope was used to observe if the sprayed coating layer obviously peeled off after the rubbings. When the peeling-off area was >20%, it was evaluated as “fail”.

### Chemical Corrosion Resistance

Reference standard: ASTM-D-1308-02 (1993)

### Test Conditions of Chemicals

A cured testing surface was soaked by the following chemicals respectively: Formula 409 multi-surface cleaner, ammonia, isopropyl alcohol (IPA), acetone, alcohol, hydrochloric acid and bleaching agent for 24 hours respectively. After the soaking liquid was removed and the liquid residues were cleaned, observing if there were evident changes on the test surfaces, if the coating layer peeled off, and if the optical performances evidently changed or not. If the change ratio of haze and light transmittance was less than 20%, it was evaluated as “pass”.

During the soaking, in order to prevent the chemicals from volatilization, it was necessary to cover the testing surface with soaked cotton pads or dust-free cloth which were then covered with a watch glass, and then seal around the watch glass with an adhesive tape.

### Appearance

Referring to the enterprise optical standard ES601048 in combination with visual observations. As compared with samples without coating layers, if sintered coating layers did not have evident color differences while keeping the coated surfaces uniform, and if it was observed with a microscopy that the antibacterial layer was adhered onto the substrate surfaces in the shape of clear bubbles, it was evaluated as “pass”. But, if the sintered coating layer was observed to have evident color differences or evident particles, it was evaluated as “Fail”.

TABLE 1
Compositions and Performance Test Results of Coating Layers

| | Ex1 | Ex2 | Ex3 | Ex4 | Ex5 | Ex6 | Ex7 | Ex8 | Ex9 |
|---|---|---|---|---|---|---|---|---|---|
| Matrix phase | TiO₂ | TiO₂ | TiO₂ | TiO₂ | TiO₂ | TiO₂ | TiO₂ | TiO₂ | TiO₂ |
| Cu (%) in TiO₂ | 8.92% | 3.13% | 14.07% | 46.04% | 1% | — | — | 8.92% | — |
| layer | | | | | | | | | |
| Cu¹⁺/Cu²⁺ | 1.64 | 1.37 | 1.18 | 0.47 | NA | NA | NA | NA | NA |
| ratio | | | | | | | | | |
| Ethanol/ | 1:1 | 1:1 | 1:1 | 1:1 | 1:1 | 1:0 | 0:1 | 70:1 | 1:70 |
| glacial acetic | | | | | | | | | |
| acid ratio | | | | | | | | | |
| pH (1^{st} step, | 0.8 | 0.8 | 0.8 | 0.8 | 0.8 | 6.9 | 0 | 4.0 | 0 |
| solution of | | | | | | | | | |
| titanium | | | | | | | | | |
| alkoxide) | | | | | | | | | |
| pH (2^{nd} step, | 0.8 | 0.8 | 0.8 | 0.8 | 0.8 | 6.9 | — | 4.0 | — |
| solution of Cu | | | | | | | | | |
| precursor) | | | | | | | | | |
| Sintering | 400 □ | 400 □ | 400 □ | 400 □ | 400 □ | NA | NA | 400 □ | NA |
| temperature | | | | | | | | | |

Performance test Results

| | | | | | | | | | |
|---|---|---|---|---|---|---|---|---|---|
| Appearance | Pass | Pass | Pass | Fail | Pass | NA* | NA | NA | NA |
| Abrasion | Pass | Pass | NA | NA | Pass | NA | NA | NA | NA |
| resistance | | | | | | | | | |
| Antimicrobial | Pass | Fail | NA | NA | Fail | NA | NA | NA | NA |
| properties | | | | | | | | | |
| Chemical | Pass | NA | NA | NA | NA | NA | NA | NA | NA |
| corrosion | | | | | | | | | |
| resistance | | | | | | | | | |

NA* denotes not tested.

The foregoing description, for purposes of explanation, used specific nomenclature to provide a thorough understanding of the disclosure. However, it will be apparent to one skilled in the art that specific details are not required in order to practice the disclosure. Thus, the foregoing descriptions of specific embodiments of the disclosure are presented for purposes of illustration and description. They are not intended to be exhaustive or to limit the disclosure to the precise forms disclosed; obviously, many modifications and variations are possible in view of the above teachings. The embodiments were chosen and described in order to best explain the principles of the disclosure and its practical applications, they thereby enable others skilled in the art to best utilize the disclosure and various embodiments with various modifications as are suited to the particular use contemplated. It is intended that the following claims and their equivalents define the scope of the disclosure.

Based on the teachings contained in this disclosure, it will be apparent to persons skilled in the relevant art(s) how to make and use embodiments of the disclosure.

It is to be appreciated that the Detailed Description section, and not the Abstract section, is intended to be used to interpret the claims. The Abstract section may set forth one or more, but not all exemplary embodiments, of the disclosure, and thus, are not intended to limit the disclosure and the appended claims in any way.

The disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) that various changes in form and detail can be made therein without departing from the spirit and scope of the disclosure. Thus the disclosure should not be limited by any of the above-described exemplary embodiments. Further, the claims should be defined only in accordance with their recitations and their equivalents.

What is claimed is:

1. A Cu-doped titania coating layer, comprising a titania binder and Cu element doped therein, characterized in that a doping amount of the Cu element is in the range of 4 to 25 mol % based on the entire cured coating layer.

2. The titania coating layer according to claim 1, characterized in that said doping amount of the Cu element in the coating layer is in the range of 8 to 16 mol %.

3. The titania coating layer according to claim 1, characterized in that the Cu⁺/Cu²⁺ ratio in the coating layer is more than 1:1, preferably more than 1:3.

4. The titania coating layer according to claim 1, characterized in that heavy metal ions rather than Cu, such as iron, silver, manganese, zinc, lead, tin, mercury, and cadmium, are present in the coating layer in an amount of less than 0.5 mol %, more preferably less than 0.1 mol %.

5. The titania coating layer according to claim 1, characterized in that said coating layer does not contain halogen elements, in particular F.

6. The titania coating layer according to claim 1, characterized in that said coating layer is in the form of a continuous coating layer constituted by an O—Ti—O network.

7. A coating composition, comprising 5.5 to 25.0 wt %, preferably 6.5 to 22.0 wt % such as 8.0 to 15.0 wt % of a titanium alkoxide, 0.15 to 4.5 wt %, such as 0.20 to 4.0 wt % or 0.30 to 3.5 wt % of a copper ion precursor, an acid containing stabilizer and an alcohol containing diluent, based on the total weight of the coating composition not counting water.

8. The coating composition according to claim 7, characterized in that said titanium alkoxide is selected from the group of titanium methoxide, titanium ethoxide, titanium propoxide, titanium isopropoxide, titanium butoxide, titanium isobutoxide, and the like, preferably titanium isopropoxide, titanium butoxide, and titanium isobutoxide, especially tetrabutyl titanate.

9. The coating composition according to claim 7, characterized in that said copper ion precursor compound is selected from the group of nitrates, carboxylates such as acetates and formates, sulfates of copper and various hydrates thereof, preferably copper nitrate and hydrates thereof.

10. The coating composition according to claim 7, characterized in that said alcohol is selected from aliphatic alcohols, preferably C₁-C₈, more preferably C₂-C₆ alcohols, such as ethanol, preferably alcohols having a purity higher than 99% or in an anhydrous form, more preferably anhydrous ethanol.

11. The coating composition according to claim 7, characterized in that said alcohol is in an amount of 20-90 wt %, preferably 24.0-86.0 wt %, such as 33.0-65.0 wt %, based on the total weight of the coating composition not counting water.

12. The coating composition according claim 7, characterized in that said acid is selected from non-oxidative inorganic acids and mono- or dicarboxylic acids, such as C₁-C₈ or C₁-C₆ aliphatic acids or C₆-C₁₂ aromatic carboxylic acids, such as acetic acid, propionic acid, butyric acid, oxalic acid, citric acid, benzoic acid, and the like, preferably acetic acid, e.g., glacial acetic acid, as well as hydrochloric acid, sulfuric acid or nitric acid.

13. The coating composition according to claim 7, characterized in that the acids is in an amount of 1.0 to 70.0 wt %, preferably 1.3 to 67.0 wt %, such as 9.0 to 55.0 wt %, based on the total weight of the coating composition not counting water.

14. The coating composition according to claim 7, characterized in that said coating composition additionally comprises acetylacetone, preferably in an amount of 0.5 to 2.3 wt %, preferably 0.7 to 2.1 wt % or 1.5 wt %, based on the total weight of the coating composition not counting water.

15. The coating composition according to claim 7, characterized in that the ratio of alcohol to acid in volume is in the range of 10:1 to 1:2, such as 8:1 to 1:1 or 5:1 to 2:1.

16. The coating composition according to claim 7, characterized in that said coating composition is in the form of a concentrated solution and in the form of an aqueous solution after being diluted by adding water.

17. The coating composition according to claim 7, characterized in that said coating composition comprises 0.8-1.6 wt %, such as 0.9-1.2 wt % of the titanium alkoxide, 0.02-1.4 wt %, preferably 0.05-1.2 wt %, of the copper ion precursor, the acid containing stabilizer and the alcohol containing diluent, and 60-98 wt % of water, based on the total weight of the coating composition.

18. A process of preparing a coating composition, comprising: (1) preparing a solution comprising a titanium alkoxide and a diluent; (2) preparing a solution comprising a copper precursor compound and a diluent, (3) mixing the above two solutions to obtain a precursor mixture of the composition, wherein in the above steps (1) and (2), the pH value of the solutions is controlled to in the range of 0.1 to 6, and the solutions of steps (1) and (2) are substantially free of water.

19. The process according to claim 18, characterized in that a stabilizer, particularly an acid containing stabilizer, is added in at least one of the steps (1) to (3), particularly in both steps (1) and (2).

20. The process according to claim 18, characterized in that acetylacetone is added, particularly in step (3).
